(19) United States
(12) Patent Application Publication
(10) Pub. No.: US 2022/0013763 A1
(43) Pub. Date: Jan. 13, 2022

(54) ELECTRODE, BATTERY CELL AND USE THEREOF

(71) Applicant: Robert Bosch GmbH, Stuttgart (DE)

(72) Inventors: Joo Young Choi, Braunschweig (DE); Younggeun Choi, Moeglingen (DE)

(21) Appl. No.: 17/289,573

(22) PCT Filed: Oct. 21, 2019
(86) PCT No.: PCT/EP2019/078513

§ 371 Date: Apr. 28, 2021

(30) Foreign Application Priority Data
Oct. 31, 2018 (DE) 10 2018 218 624.3

(51) Int. Cl. H01M 4/131; H01M 4/36; H01M 4/505; H01M 10/0525; H01M 4/62; H01M 4/525

(52) U.S. Cl. CPC H01M 4/131; H01M 4/366; H01M 4/505; H01M 2004/021; H01M 4/625; H01M 4/525; H01M 10/0525

(57) ABSTRACT

The invention relates to an electrode of a battery cell, in particular a positive electrode of a lithium-ion battery cell, in the present case in the form of an electrode layer (102, 202, 302) and comprising an active material having a plurality of active material particles (106, 206, 306), characterised in that a thickness of the electrode layer (102, 202, 302) is at least twice as large as a maximum diameter of the active material particles (106, 206, 306).

### BACKGROUND

The present invention relates to an electrode, a battery cell and the use thereof.

For the implementation of electromobility, secondary batteries, which are also referred to as rechargeable accumulators, are used for storing electrical energy. Lithium-ion batteries are particularly suitable for this purpose, owing to their high energy density, thermal stability and a low self-discharge.

In this case, a lithium-ion battery comprises one or a plurality of lithium-ion battery cells.

A lithium-ion battery cell comprises at least one pair of electrodes having a positive and a negative electrode. The positive electrode is applied to a positive current conductor and the negative electrode to a negative current conductor. An ion-conductive separator is arranged between the positive and the negative electrode, in order to avoid contact and thus a short circuit of the two electrodes. This separator can also be present in the form of an ion-conductive solid-state electrolyte.

From today's technological point of view, it is very challenging to produce lithium-ion battery cells with a high power density, owing to the limited volume in the respective battery cell housing.

One known solution involves designing battery cells of this type with thin electrode layers, particularly with thin positive electrode layers, in order to enable a shorter diffusion path for a movement of ions between the two electrodes. Consequently, thin separator layers are also required.

Further prior art is known from KR 20150015258A.

### SUMMARY

The present invention relates to an electrode of a battery cell, in particular a positive electrode of a lithium-ion battery cell, as well as to a battery cell and the use thereof with the characterizing features of the independent claims.

In this case, the electrode according to the invention is preferably present in the form of an electrode layer, the active material of which has a plurality of active material particles.

In order to be able to be used in vehicles which are in particular purely electrically driven, safety aspects, competitive production methods and a long cyclic or calendrical lifetime also play a crucial role in the case of lithium-ion battery cells in addition to technical requirements for a high energy or power density. The production methods of a positive electrode are therefore the key to meeting the specific requirements for lithium-ion battery cells.

With regard to cell performance, on the one hand, the type of positive active material is important due to its material properties, on the other hand, the type of electrode design corresponding to a microstructure design of the electrode is important. This includes, for example, establishing the size of active material particles.

Moreover, establishing an optimum layer thickness or an optimum range of values of the layer thickness with which the positive electrode can be produced in a relatively simple manner and at the same time a high power density being present in the entire cell is relevant.

According to the invention, active material particles, preferably spherical active material particles, which are located in the positive electrode have different sizes, wherein the diameters thereof vary. Moreover, positive electrodes with different layer thicknesses are used with regard to production process and cell performance in experimental cells and are compared with one another using the experimental cells, in order to determine the optimum layer thickness or the optimum range of values of the layer thickness for positive electrodes.

It can be inferred from the experiments and the associated measurements or evaluations within the context of the present invention that a positive electrode, preferably without a positive current conductor, the layer thickness of which corresponds to a maximum diameter of the active material particles, has a very low total resistance. This results in a high charging or discharging current in the entire battery cell.

However, the production process of a positive electrode of this type is relatively time-consuming and expensive, since a homogeneous surface of electrodes of this type is technically difficult to realize. This disadvantage has a substantial influence on the power of the entire cell. A plurality of battery cells are required in order to compensate for this disadvantage. However, this measure leads to high production costs and long production times.

On the other hand, the overall total resistance of a positive electrode increases if the layer thickness thereof is four times as large as a maximum diameter of the active material particles. The high total resistance results in a low charging and discharging current of the relevant electrode.

The electrode layer according to the invention therefore represents a compromise by a thickness of the electrode layer being at least twice as large as a maximum diameter of the active material particles.

Furthermore, it is advantageous if the thickness of the electrode layer is at most three times as large as the maximum diameter of the active material particles.

The particular advantage of this measure is that an optimum thickness of the electrode layer with regard to the specific capacitance thereof can be achieved in the range of 0.8 to 1.2 mAh/cm² and a simplified production process can be achieved at the same time. Moreover, the total resistance of such battery cells as the sum of the diffusion resistance thereof and the reaction resistance thereof can be reduced by means of the electrode layer according to the invention.

Further advantageous embodiments of the present invention are the subject matter of the further subclaims.

It is therefore advantageous if the thickness of the electrode layer is at least 16 μm and at most 35 μm.

Furthermore, it is advantageous if the maximum diameter of the in particular spherical active material particles is between 3 and 11.5 μm.

It is further advantageous if in particular the active material particles are coated on their surfaces with an additive, in particular carbon black. This additive helps to increase the electrical conductivity of the active material particles. In this case, the active material particles preferably comprise lithium metal oxides, wherein the metal is nickel, manganese or cobalt, for example. In this case, an alloy which is made from nickel, manganese and cobalt is also conceivable.

The invention is further related to a battery cell, in particular a lithium-ion battery cell, which has an electrode according to the invention. In this case, a thickness of the electrode layer is at least twice as large and at most three times as large as a maximum diameter of the active material particles contained in the electrode layer. If the active material particles with a maximum diameter are superimposed precisely, this results in a two-layer or three-layer positive electrode.

The electrode according to the invention can advantageously be used in battery cells such as lithium-ion battery cells or in fuel cells. They can be used in electric vehicles, in hybrid vehicles, or in stationary applications, such as for storing renewably generated energy, for example.

### BRIEF DESCRIPTION OF THE DRAWINGS

Advantageous embodiments of the present invention are represented in the drawings and are explained in greater detail in the subsequent description of the figures. In the drawings:

FIG. 1: shows the schematic representation of an electrode stack which comprises an electrode according to the invention in a first embodiment,

FIG. 2: shows the schematic representation of an electrode stack which comprises an electrode according to the invention in a second embodiment,

FIG. 3: shows the schematic representation of an electrode stack which comprises an electrode according to the invention in a third embodiment,

FIG. 4: shows the schematic representation of a battery cell containing an electrode according to the invention.

### DETAILED DESCRIPTION

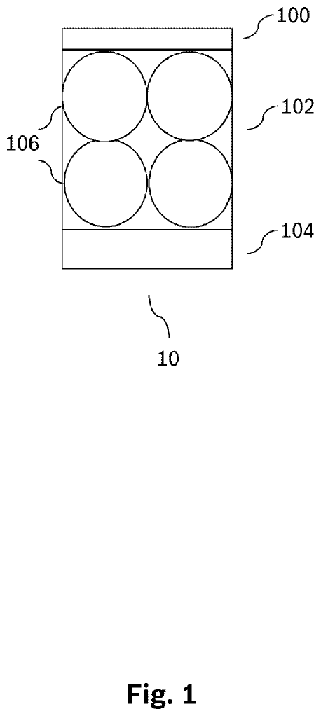

FIG. 1 schematically represents an electrode stack 10 which comprises at least one electrode 102 according to the invention in the form of an electrode layer. Furthermore, the electrode stack 10 comprises a current conductor 104, for example, on which the electrode 102 according to the invention and a separator 100 are arranged. In this case, it is advantageous if the electrode 102 is set as a positive electrode and the current conductor 104 correspondingly as a positive current conductor. A mating electrode and the current conductor thereof, which are not represented here, can additionally be associated with the electrode stack 10. The electrode stack 10 represented in FIG. 1 can also be referred to as a half cell.

The positive electrode 102 preferably has a plurality of active material particles 106 which are preferably present in the form of spherical active material particles, for example. Furthermore, the active material particles 106 are represented as being arranged on top of one another. This establishes a two-layer positive electrode 102 of active material particles 106. The arrangement of the active material particles can be different depending on the application and specific requirements.

It is advantageous if the spherical active material particles 106, for example, are coated on their surfaces with an additive, preferably conductive carbon black. The electrical conductivity of the active material particles 106 can thus be improved.

Furthermore, the positive electrode 102 can comprise one or a plurality of binding agents which connect the spherical active material particles 106, for example, to one another in a cohesive manner. In this case, the spherical active material particles 106, for example, have a maximum diameter of at least 3 and at most 11.5 μm both in a stacking direction of the electrode stack 10 and in a direction which runs perpendicular to the stacking direction. In this case, the layer thickness of the positive electrode 102 in the stacking direction preferably corresponds to twice the maximum diameter of the spherical active material particles 106.

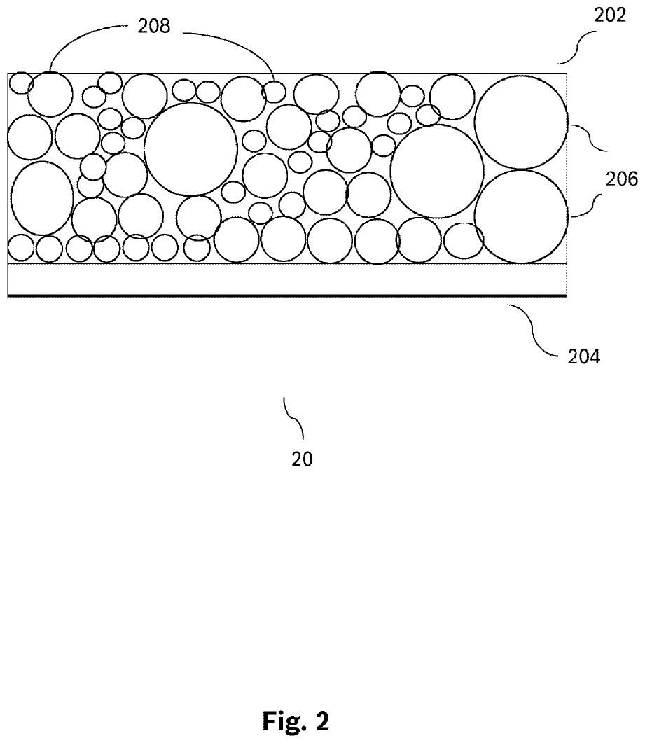

FIG. 2 represents an electrode stack 20 which comprises a positive current conductor 204, a positive electrode 202 according to the invention in the form of an electrode layer according to a further embodiment of the present invention and a separator 200, for example. A negative electrode and the negative current conductor thereof are not represented here. The positive electrode 202 according to the invention preferably has a plurality of spherical active material particles 206 which have different diameters. In this case, the layer thickness of the positive electrode 202 is twice a maximum diameter, both in a stacking direction of the electrode stack 20 and in a direction which runs perpendicular to the stacking direction, of the spherical active material particles 206.

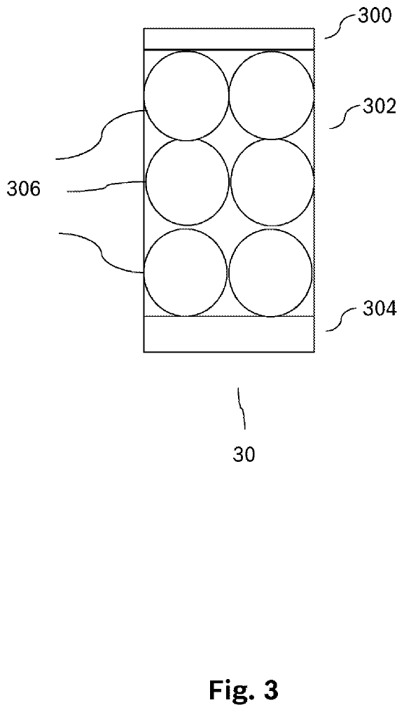

FIG. 3 represents an electrode stack 30 which comprises at least one positive current conductor 304, a positive electrode 302 according to the invention in the form of an electrode layer according to a further embodiment of the present invention and a separator 300. A negative electrode and the negative current conductor thereof are not represented here. The positive electrode 302 according to the invention preferably has a plurality of spherical active material particles 306 which are arranged superimposed, for example. This results in a three-layer positive electrode 302 of the spherical active material particles 306. The layer thickness of the positive electrode 302 in the stacking direction is advantageously three times as large as the maximum diameter of the spherical active material particles 306 in the stacking direction of the of the electrode stack 30 and also in a direction which runs perpendicular to the stacking direction. The spherical active material particles 306 can include lithium metal oxides, for example, wherein the metal contains nickel, manganese or cobalt or an alloy which is made from nickel, manganese and cobalt. With regard to the electrical conductivity of the positive electrode layer 302, the active material particles 306 can preferably be coated on their surfaces with an additive, preferably carbon black.

In the embodiments according to the invention which are represented in FIGS. 1, 2 and 3, the layer thickness of the positive electrodes 102, 202 and 302 is preferably a value between 16 and 35 μm.

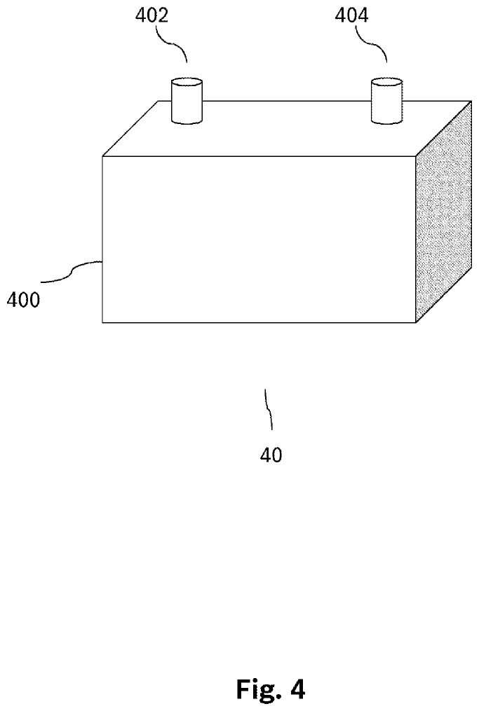

The electrode stacks 10, 20 and 30 which comprise positive electrode layers 102, 202 and 302 are used in a battery cell 40 represented in FIG. 4, for example. In this case, in the interior of the battery cell housing 400, the battery cell 40 comprises at least one electrode stack 10, 20 and 30 which is not represented and by means of which electrical energy can be stored. Furthermore, the battery cell 40 preferably has a negative terminal 402 and a positive terminal 404 for connecting to further battery cells.

The electrode stack described can advantageously be used for battery cells such as lithium-ion battery cells or fuel cells. They can be used in electric vehicles, in hybrid vehicles, or in stationary applications, such as for storing renewably generated energy, for example.

1. An electrode of a battery cell present in the form of an electrode layer (102, 202, 302) and comprising an active material with a plurality of active material particles (106, 206, 306), characterized in that
a thickness of the electrode layer (102, 202, 302) is at least twice as large as a maximum diameter of the active material particles (106, 206, 306).

2. The electrode as claimed in claim 1, characterized in that
the thickness of the electrode layer (102, 202, 302) is at most three times as large as the maximum diameter of the active material particles (106, 206, 306).

3. The electrode as claimed in claim 1,
characterized in that
the electrode layer (102, 202, 302) comprises at least two layers of active material particles (106, 206, 306), which are arranged superimposed, with a maximum diameter.

4. The electrode as claimed in claim 1,
characterized in that
the electrode layer (102, 202, 302) comprises at most three layers of active material particles (106, 206, 306), which are arranged superimposed, with a maximum diameter.

5. The electrode as claimed in claim 1,
characterized in that the thickness of the electrode layer (102, 202, 302) is at least 16 μm and at most 35 μm.

6. The electrode as claimed in claim 1,
characterized in that
the maximum diameter of the active material particles (106, 206, 306) is between 3 and 11.5 μm.

7. The electrode as claimed in claim 1,
characterized in that
the active material particles (106, 206, 306) are coated on their surface with an additive.

8. The electrode as claimed in claim 1,
wherein the active material particles (106, 206, 306) include lithium metal oxides, and wherein the metal is nickel, manganese or cobalt or an alloy which is made from nickel, manganese and cobalt.

9. A battery cell with at least one positive electrode (102, 202, 302) as claimed in claim 1.

10. The use of a battery cell, as claimed in claim 9, in an electric vehicle (EV), in a hybrid vehicle (REV), or in a plug-in hybrid vehicle (PHEV).

11. The electrode as claimed in claim 1, characterized in that the electrode is a positive electrode of a lithium-ion battery cell.

12. The electrode as claimed in claim 6, characterized in that the active material particles (106, 206, 306) are spherical.

13. The electrode as claimed in claim 6, characterized in that the additive is carbon black.

14. The battery cell as claimed in claim 9, characterized in that the battery cell is a lithium ion battery cell.
